(19) United States
(12) Patent Application Publication
(10) Pub. No.: US 2011/0277389 A1
(43) Pub. Date: Nov. 17, 2011

(54) MAGNETICALLY LEVITATED ANTISEISMIC STRUCTURE

(75) Inventor: Chang Xia, Fuzhou (CN)

(73) Assignee: FUZHOU PLANNING DESIGN & RESEARCH INSTITUTE, Fuzhou (CN)

(21) Appl. No.: 13/173,770

(22) Filed: Jun. 30, 2011

Related U.S. Application Data
(63) Continuation of application No. PCT/CN2009/071834, filed on May 18, 2009.

(30) Foreign Application Priority Data
Jan. 21, 2009 (CN) 200910110931.6
Apr. 28, 2009 (CN) 200910111587.2

(51) Int. Cl. E04H 9/02; H02K 7/09

(52) U.S. Cl. 52/1; 310/90.5

(57) ABSTRACT

A magnetically levitated antiseismic structure comprises a main structure and one or more substructures. A first electromagnet is arranged at a base of the substructure and a corresponding second electromagnet is arranged on the substrate beneath the first electromagnet, both of the first and second electromagnets having the same electromagnetic polarity when they are electrically connected to a power source. The first and second electromagnets are electrically connected to an electromagnetic control device, and the electromagnet control device including an earthquake signal receiver. The present invention can effectively free people from damages and injuries from the earthquake.

### CROSS-REFERENCE TO RELATED APPLICATIONS

This application is a continuation of International Patent Application No. PCT/CN2009/071834, with an international filing date of May 18, 2009, designating the United States, now pending, which is based on Chinese Patent Application No. 200910110931.6, filed Jan. 21, 2009, and Chinese Patent Application No. 200910111587.2, filed Apr. 28, 2009. The contents of these specifications are incorporated herein by reference.

### BACKGROUND OF THE INVENTION

1. Field of the Invention

The present invention relates to a structure, and in particular, to a magnetically levitated antiseismic structure.

2. Description of the Related Art

In the current structure, especially buildings, the earthquake disaster is prevented by way of reinforcing structure or installing rubbers at the base of the structure. Although these methods play a huge role in the earthquake disaster prevention, they can not remove damages on the structure. Especially, in the high-rise or super high-rise buildings, excessive deformation and acceleration are easy to happen during the earthquake, which will cause damages of integral structure and internal facilities and casualties.

### SUMMARY OF THE INVENTION

In view of the above-described problem, it is one objective of the present invention to provide an antiseismic structure, which can effectively free people from damages and injuries from the earthquake.

To achieve the above objectives, in accordance with one embodiment of the invention, provided is a magnetically levitated antiseismic structure, comprising a main structure and one or more substructures. A first electromagnet is arranged at the base of the substructure and a corresponding second electromagnet is arranged on the substrate beneath the first electromagnet, both of the first and second electromagnets having the same electromagnetic polarity when they are electrically connected to a power source. The first and second electromagnets are electrically connected to an electromagnetic control device, the electromagnet control device including an earthquake signal receiver.

In a class of this embodiment, the substructure is a single structure body, a single device, or a single instrument.

In a class of this embodiment, the base is the chassis of the substructure or the base of a bearing member.

In a class of this embodiment, the first electromagnet and second electromagnet are conducting electromagnets or super-conducting electromagnets.

In accordance with one embodiment of the invention, provided is a magnetically levitated antiseismic structure. A first electromagnet is arranged at the base of said antiseismic structure and a corresponding second electromagnet is arranged on the substrate beneath the first electromagnet, both of the first and second electromagnet having the same electromagnet polarity when they are electrically connected to a power source; and the first electromagnet and second electromagnet are electrically connected to an electromagnetic control device, the electromagnetic control device including an earthquake signal receiver.

In a class of this embodiment, the structure is a single structure body, a single device, or a single instrument.

In a class of this embodiment, the base is the chassis of the structure or the base of a bearing member.

In a class of this embodiment, the first electromagnet and second electromagnet are conducting electromagnets or super-conducting electromagnets.

A magnetically levitated antiseismic structure can be used on the newly built or reconstructed single storey building, multistory building, high-rise building or super high-rise building, industrial building, public building, long-span spatial structure, tower, offshore platform, nuclear power plant structure, special structure, the enforcement of the preceding structures, and devices and instruments.

Advantage of the invention comprise:

1. According to the magnetically levitated antiseismic structure provided in the present invention, no mechanical characteristics are involved: 1) The structure has no wear and contamination and can be used for a long time; 2) The structure has no mechanical friction, small power consumption, low noise, high efficiency, no need of lubricating and sealing; 3) The structure has adjustable electromagnetic force, rigidity, and damp, and is easy to stay balanced without shocks, and convenient for active control in case of shocks; 4) All moving characteristics of the suspension part in the structure can be obtained by the sensor, which is convenient for running status diagnosing and monitoring.

2. The magnetically levitated antiseismic structure provided in the present invention can effectively prevent the structure from the impact from the shocks, especially shocks produced by the earthquake.

3. The first electromagnet and the second electromagnet in the present invention can be easily inspected and replaced or repaired.

4. The application of the magnetically levitated antiseismic structure provided in the present invention is extensively.

### BRIEF DESCRIPTION OF THE DRAWINGS

Detailed description will be given below in junction with accompanying drawings, in which:

FIG. 1 is a principle schematic view of a structure according to a first embodiment of the present invention;

FIG. 2 is a principle schematic view of a structure according to a second embodiment of the present invention;

FIG. 3 is a principle schematic view for a working state of a structure according to the second embodiment of the present invention; and

FIG. 4 is a principle schematic view of a structure according to a third embodiment of the present invention.

Numeral reference: 1—Second electromagnet; 2—First electromagnet; 3—Base; 4—Main structure; 5—Earthquake signal receiver; 6—Electromagnetic control device; 7—Conducting line; 8—Substructure; 41—Chassis; 42—Base of the bearing member.

### DETAILED DESCRIPTION OF THE INVENTION

For better understanding of various embodiments of the present invention, specific embodiments will be described as follows in combination with accompanying drawings.

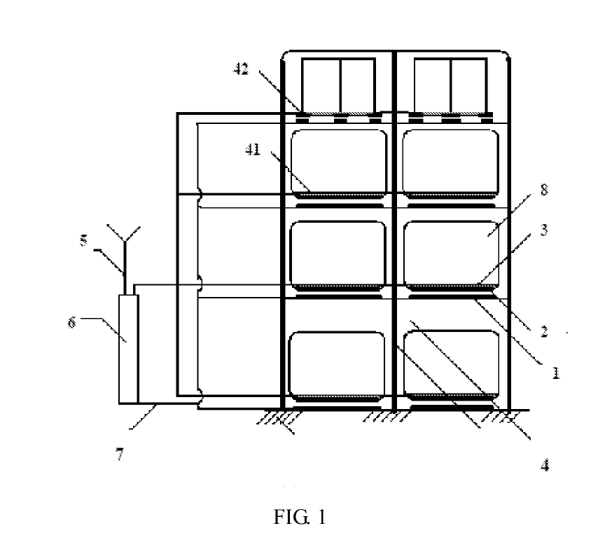

In high-rise or supper high-rise buildings, a system of the main structure and substructures is used for structure design. As show in FIG. 1, a structure view of a structure according to a first embodiment of the present invention is illustrated. A mega-structure includes a main structure 4, and the main structure 4 includes one or more substructures 8. Each of the substructures 8 adopts the magnetically levitated antiseismic structure. To be specific, a base 3 of each of the substructures 8 is arranged with a first electromagnet 2, and a second electromagnet 1 is arranged on the substrate of the horizontal compartment. In the event of an earthquake, the main structure 4 receives signals through an earthquake receiver 5, starts an electromagnetic control device 6, and supplies current for the first electromagnet 2 and the second electromagnet 1. Accordingly, a repulsive force is generated between the two electromagnets 1 and 2. Under this force, the substructure 8 rises and leaves from the base of the main structure. In this way, the substructure 8 is not affected by the shocks of the main structure.

According to embodiments of the present invention, the first electromagnet 2 and the second electromagnet 1 are conducting electromagnets or super-conducting electromagnets. A second embodiment and third embodiment as follows describe the two setting mode for the first electromagnet 2 and the second electromagnet 1, is that, directly disposing the first electromagnet 2 at the base 3 of the antiseismic structure, and directly disposing the multiple first electromagnets 2 at the base 42 of a bearing member.

In the structure using the traditional antiseismic method, the vertical members (for example, shear walls) may be arranged with elevator, stairs, and ventilation wells. During an earthquake, the substructure 8 is levitated, and does not generate any horizontal force; therefore the shock force to main structure 4 is greatly reduced, and the main structure 4 is more cost-efficient and safer as compared against the traditional antiseismic structure.

According to a first embodiment of the present invention, a magnetically levitated antiseismic structure includes a main structure 4 and one or more substructures 8. The substructure 8 may be a single structure body, a single device, or a single instrument. A first electromagnet 2 is arranged at the base of the substructure 8 and a corresponding second electromagnet 1 is arranged on the substrate beneath the first electromagnet 2, both of said first and second electromagnets having the same electromagnetic polarity when they are connected to a power source. The first and second electromagnets are connected to an electromagnetic control device, the electromagnet control device including an earthquake signal receiver.

In the high-rise or supper high-rise buildings, a system of the main structure and substructures is used for structure design, and shock absorption (isolation) technique is used for wind-resistant design. In addition, the traditional antiseismic design is used in the main structure, and the magnetically levitated antiseismic design is used in the substructures. In this way, the advantages of each technique are brought into full play, the substructures are prevented from shocks, and safeties in the main structure and internal facilities are ensured.

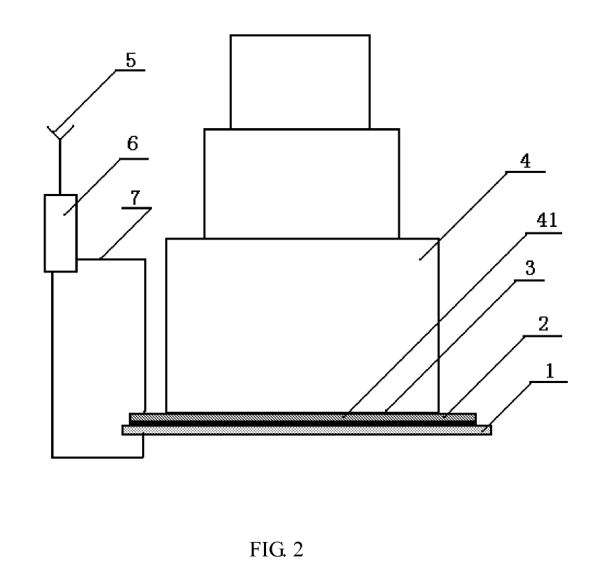

FIG. 2 is a structure view of a structure according to the second embodiment of the present invention. In this embodiment, a first electromagnet 2 is arranged at the base 3 of the antiseismic structure, a second electromagnet 1 is arranged on the substrate beneath the first electromagnet 2. Both of the first and second electromagnets have the same electromagnetic polarity when they are connected to a power source. The first and second electromagnets are connected to an electromagnetic control device 6 through a conducting wire 7. The electromagnet control device 6 includes an earthquake signal receiver 5.

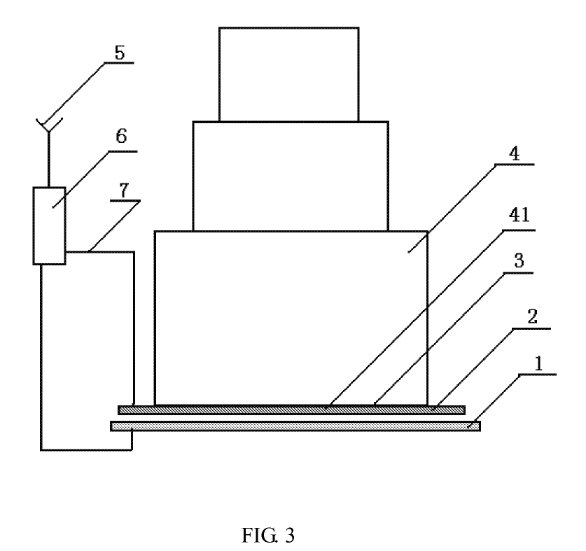

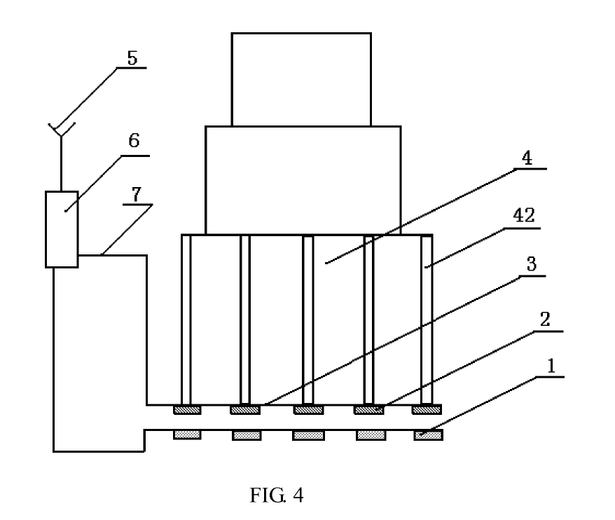

In practice, the antiseismic structure is contact with the substrate and the first electromagnet 2 is directly arranged on the second electromagnet 1. In the event that an earthquake takes place or is predicted, the earthquake monitoring device sends signals in real time. The signals are received by the earthquake signal receiver 5. Upon receiving the signals, the earthquake signal receiver 5 starts the electromagnetic control device 6 immediately. The electromagnetic control device 6 supplies current for the first electromagnet 2 and second electromagnet 1 through the conducting wire 7. The first and second electromagnets have the same electromagnetic polarity when they are connected to a power source. Therefore, a repulsive force is generated therebetween, as shown in FIGS. 3 and 4. In this case, the first electromagnet 2 moves the antiseismic upward through the base 3 and finally the structure leaves the substrate.

After the earthquake, the signals become weak and the electromagnetic control device 6 slowly reduces the current supplied for the first electromagnet 2 and second electromagnet 1 so that the repulsive force between the two electromagnets is reduced and the structure moves to the original position. Because the antiseismic structure leaves the ground during the shock, the impact caused by the earthquake to the structure is eliminated.

As shown in FIG. 3, a working state of the structure according to the second embodiment of the present invention is illustrated. The base 3 refers to the chassis 41 of the antiseismic structure.

As shown in FIG. 4, it is a structure view of a structure according to the third embodiment of the present invention. The antiseismic structure shown in FIG. 4 is the same as that shown in FIG. 2. The difference is that the antiseismic structure includes multiple first electromagnets 2 arranged at the base 42 of a bearing member, and multiple second electromagnets 1 arranged at the base and corresponding to the first electromagnets 3. The first and second electromagnets having the same electromagnetic polarity repel each other when they are connected to a power source. Therefore, as described in the second embodiment, in the event of an earthquake, the antiseismic structure, driven by the repulsive force generated between the electromagnets, moves upward. In this way, the impact caused by the earthquake is prevented.

The magnetically levitated antiseismic structure according to the present invention can be used on the newly built or reconstructed single storey building, multistory building, high-rise building or super high-rise building, industrial building, public building, long-span spatial structure, tower, offshore platform, nuclear power plant structure, special structure, the enforcement of the preceding structures, and devices and instruments.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

What is claimed is:

1. A magnetically levitated antiseismic structure, comprising:
a main structure;
one or more substructures;
a first electromagnet;
a second electromagnet;
a power source;
an electromagnetic control device; and
an earthquake signal receiver;
wherein
the first electromagnet is arranged at a base of said substructure, the second electromagnet is arranged on the substrate beneath said first electromagnet and corresponding to said first electromagnet;
both of said first and second electromagnets having the same electromagnetic polarity when they are electrically connected to the power source; and
said first and second electromagnets are electrically connected to the electromagnetic control device, and said electromagnet control device comprising the earthquake signal receiver.

2. The magnetically levitated antiseismic structure according to claim 1, wherein said substructure is a single structure body, a single device, or a single instrument.

3. The magnetically levitated antiseismic structure according to claim 1, wherein said base is a chassis of said substructure or the base of a bearing member.

4. The magnetically levitated antiseismic structure according to claim 1, wherein said first electromagnet and second electromagnet are conducting electromagnets or super-conducting electromagnets.

5. The magnetically levitated antiseismic structure according to claim 1, wherein said antiseismic structure can be used on the newly built or reconstructed single storey building, multistory building, high-rise building or super high-rise building, industrial building, public building, long-span spatial structure, tower, offshore platform, nuclear power plant structure, special structure, the enforcement of the preceding structures, and devices and instruments.

6. A magnetically levitated antiseismic structure, comprising
a first electromagnet;
a second electromagnet;
a power source;
an electromagnetic control device; and
an earthquake signal receiver;
wherein the first electromagnet is arranged at a base of said antiseismic structure, the second electromagnet is arranged on the substrate beneath said first electromagnet and corresponding to said first electromagnet;
both of said first and second electromagnet having the same electromagnet polarity when they are electrically connected to the power source; and
said first electromagnet and second electromagnet are electrically connected to the electromagnetic control device, and said electromagnetic control device comprising the earthquake signal receiver.

7. The magnetically levitated antiseismic structure according to claim 6, wherein said structure is a single structure body, a single device, or a single instrument.

8. The magnetically levitated antiseismic structure according to claim 6, wherein said base is a chassis of said structure or the base of a bearing member.

9. The magnetically levitated antiseismic structure according to claim 6, wherein said first electromagnet and second electromagnet are conducting electromagnets or super-conducting electromagnets.

10. The magnetically levitated antiseismic structure according to claim 6, wherein said antiseismic structure can be used on the newly built or reconstructed single storey building, multistory building, high-rise building or super high-rise building, industrial building, public building, long-span spatial structure, tower, offshore platform, nuclear power plant structure, special structure, the enforcement of the preceding structures, and devices and instruments.
